(19) United States
(12) Patent Application Publication
(10) Pub. No.: US 2004/0140626 A1
(43) Pub. Date: Jul. 22, 2004

(54) Sealing device

(76) Inventors: Matthew C. Hall, Littleton, CO (US); Gary Grimm, Littleton, CO (US)

Correspondence Address: David F. Zinger, SHERIDAN ROSS P.C., Suite 1200, 1560 Broadway, Denver, CO, 80202-5141, US

(21) Appl. No.: 10/346,349

(22) Filed: Jan. 16, 2003

(51) Int. Cl. F16J 15/32

(52) U.S. Cl. 277/549

(57) ABSTRACT

A sealing device that includes at least an integral base and sealing lip is provided. The sealing device can operate over thousands of cycles of operation without unacceptable wear and over a substantial range of possible temperatures. The dimensions and/or geometric shapes of the sealing lip contribute to the desired sealing results when the sealing device is part of a piston assembly, a valve assembly, a spool assembly or other appropriate assembly. One or more of the structural features can be included in the sealing device. These features can relate to the height, thickness(es) and angle of the sealing lip.

### FIELD OF THE INVENTION

The present invention relates to a device that maintains a desired seal when used and, in particular, to a device that integrally incorporates a seal adjacent an edge thereof.

### BACKGROUND OF THE INVENTION

Proper sealing is a key objective to be served in a great number of applications. Different sealing solutions have been successfully devised and advanced. These solutions include well-known implementations that rely on integrating a seal into an assembly, whereby fluid movement or escape in at least one direction relative to the assembly is to be prevented or essentially prevented. In this type of application, the sealing portions are commonly provided at the outside areas or along the periphery of the device. Such a device can be movable, for example, as part of a piston assembly, valve assembly or spool assembly, so that an acceptable seal is maintained during its movement.

Depending upon the operations and/or environments associated with the particular sealing application, not all seal designs are suitable or satisfactory. In some applications, substantial numbers of operative cycles or movements of the device are required as part of normal operation. Such a device could also be subject to a wide range of temperatures. Furthermore, the device might wear to an extent that replacement or refurbishment of the device is required at a relatively inordinate amount of times. The wear may result in the loss of the sealing function and/or removal of sealing material that separates from the sealing device as a result of such movements. Although large numbers of seal designs are available, the need exists for a sealing device that avoids unacceptable wear, maintains its sealing function after tens of thousands of cycles of operation, flexes sufficiently to achieve the desired sealing function and any loss of sealing material does not affect proper operation, as well as having the capability of meeting these requirements throughout a substantially wide range of operating temperatures.

### SUMMARY OF THE INVENTION

In accordance with the present invention; a sealing device is provided that is uniquely configured and has sealing portions that are integral with the remaining or other portions of the sealing device. The unique configuration of the sealing device, particularly the sealing portions, includes novel geometric, structural and/or dimensional aspects. In one embodiment, one of these novel features is incorporated into the sealing device. In another embodiment, a plurality of these features are incorporated into the sealing device. In other embodiments, all such features are part of the sealing device.

These novel physical characteristics substantially reside in sealing portions or a lip. The lip is flexible or movable to enable proper sealing to be maintained during relative movement involving the sealing device and other parts or components with which the sealing device is incorporated or included, such as a piston assembly, a valve assembly or a spool assembly. The sealing device includes a base that has a base transition surface. In one embodiment, the base transition surface can be contiguous and integral with a terminating surface of a boss. According to this embodiment, the boss extends from the base transition surface and preferably has a smaller width or diameter than the width or diameter of the base. The base also has a center axis and an edge. The edge is located about the periphery or circumference of the body of the base. The lip preferably extends completely around this periphery or circumference.

The lip has an inner wall and an outer wall. The inner wall is closer to the center axis than is the outer wall. In a preferred embodiment, the outer wall has upper portions and the inner wall has upper portions and in which the outer wall upper portions taper inwardly towards the inner wall upper portions. The lip can have one or more thicknesses that extend between the inner and outer walls. In addition to the one or more thicknesses, a particular one cross-section of the lip can also be defined as having a height. Preferably, the height of the lip is substantially the same, but need not be, for each cross-section that could be defined along the periphery or perimeter of the lip.

In one embodiment in which the height is the same or substantially the same throughout the lip, the height is at least 1.25 mm, preferably at least 1.80 mm and more preferably about 2.22 mm±10%. In one embodiment, no thickness of the lip is greater than 0.90 mm and preferably the thickness is not greater than about 0.70 mm±10% at any cross-section of the lip. In one embodiment, one or more cross-sections can be defined to have a height to thickness ratio. This ratio is at least 2.5 and preferably about 3.0±10%.

In a preferred embodiment, the thickness of the lip for any cross-section varies and this variance is substantially consistent throughout the perimeter of the lip so that any cross-section along the perimeter is essentially the same. The thickness preferably decreases along the height of the lip from adjacent the base transition surface outwardly. Specifically, the height of the lip can be defined as extending between an inner end and an outer end of the lip. The inner end essentially terminates at the base transition surface. The outer end is the free end of the lip and constitutes the termination of the lip. Accordingly, the thickness of the lip decreases from the inner end to the outer end.

In one embodiment, the lip defines a non-perpendicular angle relative to the base. In particular, the inner wall of the lip is straight or substantially straight. This substantially straight inner wall is definable as intersecting with a line that is perpendicular to the boss transition surface. This inclined lip angle is at least 15° and preferably 30°±10%.

Based on the foregoing summary, a number of important advantages of the present invention are recognized. An integral seal is provided as part of a movable device that effectively operates to prevent unwanted fluid passage. This desired result is achieved throughout substantial numbers of cycles of operation. The acceptable seal is present throughout a wide range of possible temperatures. The uniquely configured sealing device substantially eliminates or reduces any need for replacement or cleaning due to premature wear. The unique configuration is characterized by one or more dimensional and geometric shapes particularly found in the sealing portions or lip of the sealing device. These one or more structural aspects provide the desired seal flexibility while avoiding unwanted wear during the thousands of cycles of operation at many possible temperatures.

Additional advantages of the present invention will become readily apparent from the following discussion, particularly when taken together with the accompanying drawings.

### BRIEF DESCRIPTION OF THE DRAWINGS

FIG. 1 is an elevational view of a prior art device for sealing;

FIG. 2 is a perspective view of a sealing device of the present invention;

FIG. 3 illustrates the sealing device of FIG. 2 being able to function as a piston in combination with other components of a piston assembly;

FIG. 4 is a longitudinal cross-sectional view of the sealing device of FIG. 2; and

FIG. 5 is an enlarged, fragmentary cross-section of the lip of the sealing device of FIG. 2.

### DETAILED DESCRIPTION

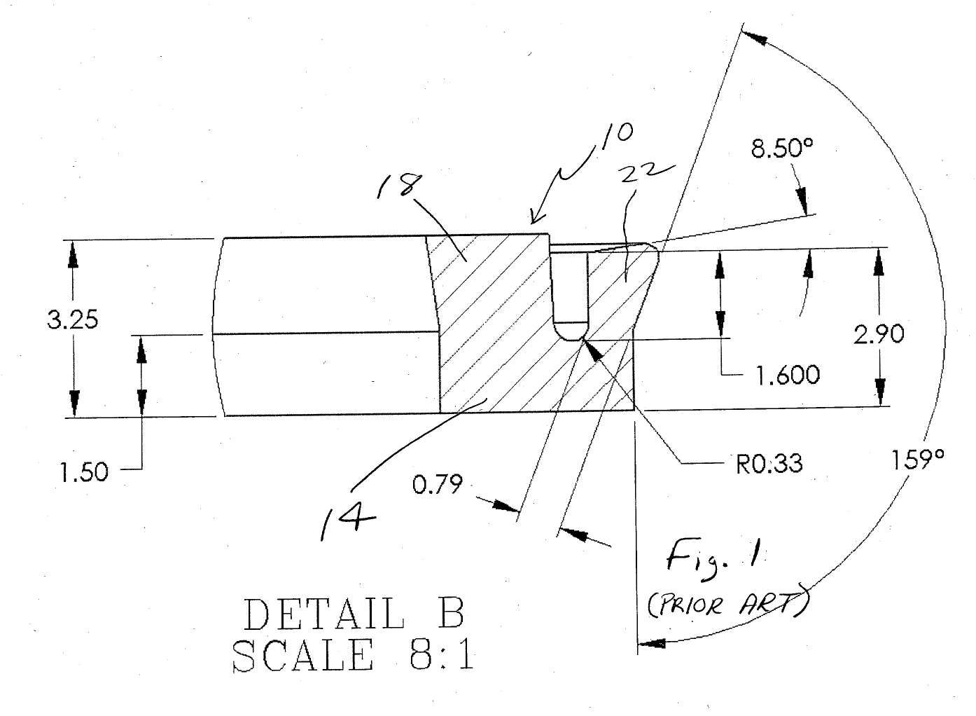

With reference to FIG. 1, a prior art sealing member 10 is illustrated that can be assembled to another component in order to provide desired sealing. The sealing member 10 includes a body 14, a head 18 and a sealing rim 22. The head 18 extends from the body 14. The head 18 has a width or diameter that is less than that of the body 14. The sealing rim 22 is located at a peripheral edge of the body 14. The sealing rim 22 has a perimeter or circumferential periphery that extends continuously around the peripheral edge of the body 14.

The structure, geometry, material composition and/or dimensions of the sealing rim 22 may render it unacceptable for some uses, particularly certain applications involving tens of thousands of cycles of operations during which the sealing rim 22 is required to move. Some drawbacks may be found in the shape (e.g. height and thickness) of the sealing rim 22, as well as the angle that it makes with the body 14 of the sealing member 10. More specifically, the sealing rim 22 has a height that extends between the area along which the bottom of the sealing rim 22 joins or is integral with the body 14 to its opposite or free end. This height is about 1.70 mm. The sealing rim also has multiple thicknesses, as viewed along its cross-section of FIG. 1. Each thickness can be defined as being between an inner surface and an outer surface of the sealing rim 22. The inner surface is closer to the head 18 than is the outer surface. The thickness of the sealing rim at its joinder with the body 14, is about 0.79 mm. The thickness of the sealing rim 22 along its height increases. That is, there are greater thicknesses in a direction from the joining end to near the opposite or free end. The thickness of the sealing rim 22 increases, including increasing for some extent from about the mid-portions of the sealing rim 22 height towards the free end of the sealing rim 22. Accordingly, there are one or more greater thicknesses in the upper half of the height of the sealing rim 22 than in its lower half. It is further noted, with respect to portions of the sealing rim 22 adjacent its free end, that an angle can be defined using the free end edge that is inclined in an upward direction from the inner surface to the outer surface. Such an angle may be ill-suited for some applications.

Likewise, unsatisfactory performance involving particular sealing applications can occur due to the angle formed between the inner surface of the sealing rim 22 and a line associated with the end surface of the body 14, which is identified in FIG. 1. This sealing rim angle is substantially 90° since the inner surface defines a substantially straight, vertically extending (non-inclined) line. This lack of inclination or 90° angle can contribute to a lack of required flexibility in some desired applications.

Referring next to FIG. 2, a perspective view of the sealing device 30 of the present invention is illustrated. The sealing device 30 is an integral, one-piece unit that eliminates the need for joining sealing portions to another component. The sealing device 30 can be relatively inexpensively injection molded using an elastomer material. The sealing device 30 can be defined as comprising a base 34 that has a bottom or free end 38. The body of the base 34 is cylindrical in shape and extends from the bottom end 38 to a base transition surface 42. Sealing portions or sealing lip 46 are joined to or integral with the peripheral edge of the base transition surface 42. The sealing lip 46 extends upwardly and outwardly for a desired distance or height. In one embodiment the sealing device 30 can also have a boss 50 that is integral with a base transition surface 42 and extends vertically therefrom. The boss has a smaller width or diameter than that of the base 34. In other embodiments, no boss is included or utilized.

The sealing device 30 can be incorporated into a piston assembly, valve assembly, spool assembly or other assembly to form a dynamic seal for pneumatic components. The sealing device 30 achieves a leakage less than 20 sccm, in the temperature range of −25° F. to 175° F. The sealing device 30 is designed to optimize use of an elastomer identified as a Hytrel 4069 grade of material (40 shore D durometer) available from Dupont, although other grades are suitable for less stringent applications.

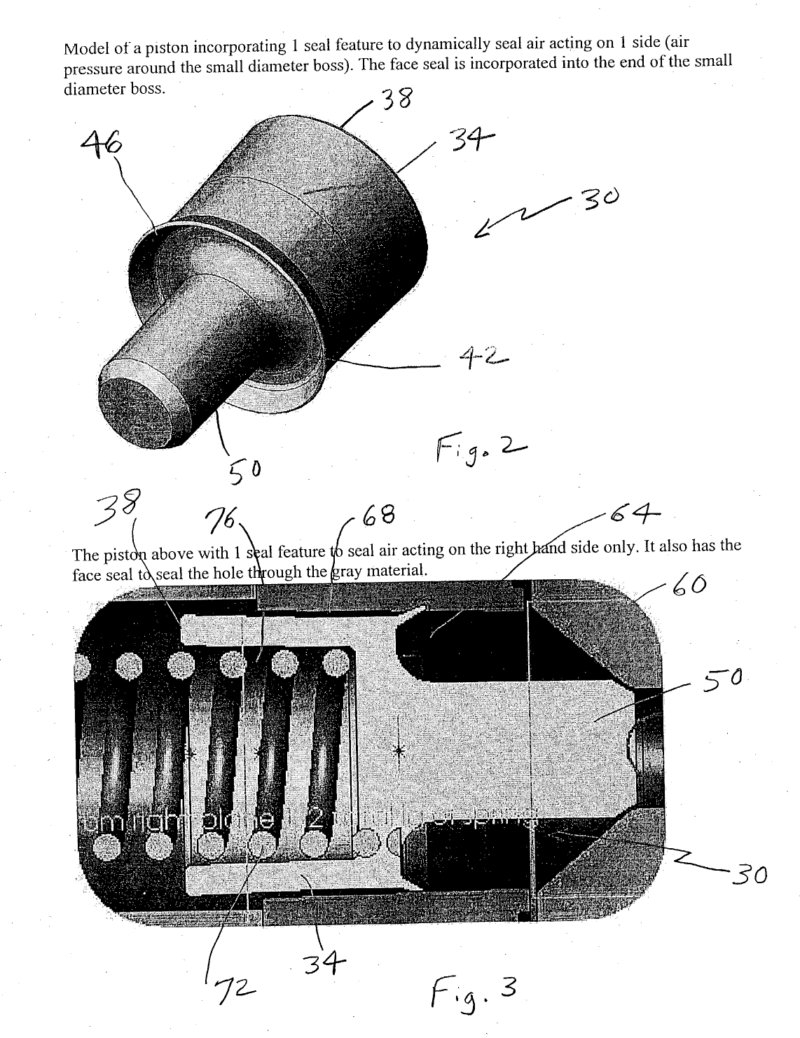

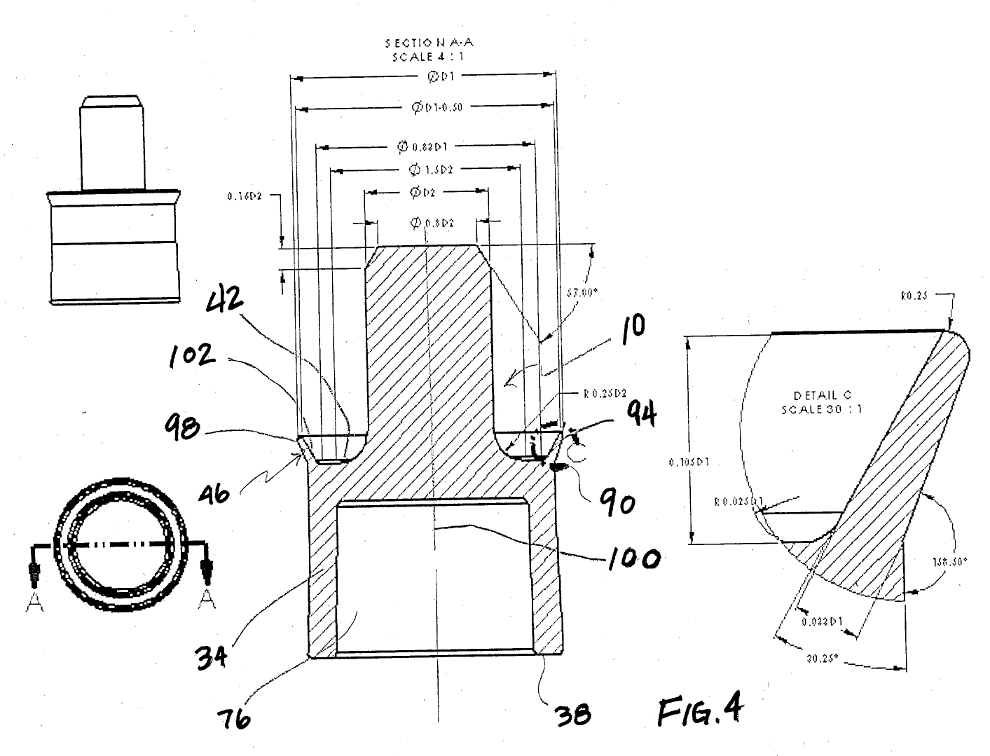

With reference to FIG. 3, the sealing device 30 is illustrated as a piston and is part of a representative piston assembly 60. In this representative design, the piston assembly 60 has a one seal feature in that it seals air acting on one side of the base 34, which side is the side from which the boss 50 extends. In this embodiment, the piston assembly 60 has a bore 64 into which the sealing device 30 acting as the piston can be positioned. The bore 64 is defined by a piston inner surface 68. In one embodiment, a compression spring 72 (spring return) is part of the piston assembly 60 design and portions thereof are containable in the chamber 76 formed with the base 34 of the sealing device 30. Other piston assembly designs are feasible including use of an air return instead of a spring return. The air return relies on air pressure to cause desired movement of the piston. According to one application of the piston assembly 60, the sealing device 30 is caused to move relative to the bore 64 during substantial numbers of cycles of operation. During such movements of the sealing device 30, the sealing lip 46 maintains proper sealing along the piston inner surface 68. Even after tens of thousands of cycles, it was observed that the sealing lip 46, particularly the material thereof, had not unwantedly worn away. Unsatisfactory leakage at the point or area of contact between the portions of the sealing lip 46 and the piston inner surface 68 do not occur. Instead, sufficient flexing of the sealing lip 46 continued to achieve acceptable sealing results. Relatedly, since unwanted or undue wear does not occur, it was not necessary to disassemble the piston assembly 60 in order to clean away or remove sealing lip 46 material from between the sealing device 30 and the piston inner surface 68. Instead of wearing, the sealing lip 46 was observed to flex inwards to take up the space between the OD of the sealing lip 46 and the ID of the bore 64.

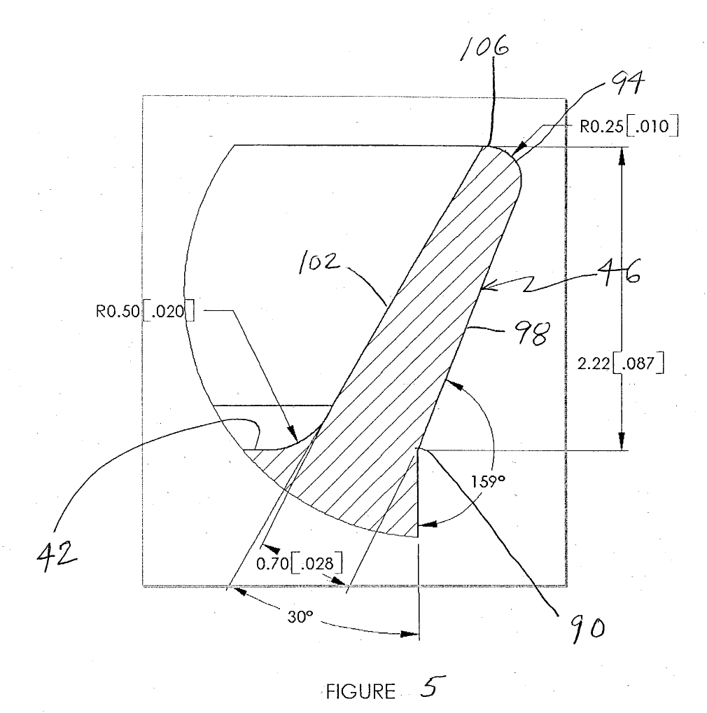

Referring to FIGS. 4 and 5, the sealing device 30 will be discussed, particularly related to the structure, geometry and dimensions associated with the sealing lip 46 as seen from longitudinal cross-sectional views. As depicted in FIG. 4, the sealing lip 46 can be defined as including an inner end 90 that is integral with the peripheral edge of the base transition surface 42. The opposite end of the sealing lip 46 is an outer or free end 94. The sealing lip 46 also has an outer wall 98 that constitutes the outermost area or surface of the sealing lip 46 and an inner wall 102 that is closer to a base center axis 100 and the boss 50 than is the outer wall 98.

Referring also to FIG. 5, which illustrates one or at least a first cross-section of the sealing lip 46, a height thereof is defined between the inner and outer ends 90, 94. This height has a relatively greater magnitude or is longer to increase flexibility of the sealing lip 46. Additionally, the thickness of the sealing lip 46 along its height can be relatively greater or wider to provide adequate strength. The height of the sealing lip 46 is at least 1.25 mm in order to achieve suitable flexibility and strength. More preferably, the height of the sealing lip 46 is at least 1.8 mm. Most preferably, the height of the sealing lip 46 is 2.2 mm±10%. With regard to the thickness between the outer and inner walls 98, 102, no thickness along the height of the sealing lip 46 is greater than 0.9 mm. Preferably, no thickness along the height of the sealing lip 46 is greater than 0.7 mm±10%. Most preferably, each cross-section of the sealing lip 46 that can be defined along its perimeter or circumference varies along its height. More specifically, the variable thickness decreases from the sealing lip inner end 90 to its outer end 94. In one embodiment, the thickness of the sealing lip 46 starts at about 0.7 mm adjacent the inner end 90 and reduces to about 0.4 mm at the outer end 94. The 0.7 mm is considered to provide sufficient strength for the life (increased durability) of the sealing device 30, but small enough in magnitude to be flexible (improve sealing and response properties), while allowing the thickness of the sealing lip 46 material to readily fill the remaining height of the sealing lip 46. Based on these thickness requirements, it is preferred that the upper half of the height of the sealing lip 46 have no thickness that is greater than any thickness in the lower half of the height of the sealing lip 46.

The height and thickness of the sealing lip 46 can also be described together. In particular, a ratio of the height to the thickness can be defined for the sealing lip 46. In one embodiment, the ratio of the height to the thickness is at least 2.5, where the thickness used in the ratio for a particular cross-section of the sealing lip 46 is the greatest thickness for that cross-section. Stated another way, no thickness for that particular cross-section is greater than the thickness used in the ratio. In another embodiment, the ratio of the height to such a thickness is at least 3.0. In a preferred embodiment, any cross-section along the perimeter of the sealing lip 46 is essentially the same.

With continued reference to FIG. 5, the outer end 94 of the sealing lip 46 can be characterized as including a tip 106. This tip 106 is more adjacent the inner wall 102 than it is to the outer wall 98 of the sealing lip 46. In accordance with this geometry, the upper portions of the height of the sealing lip 46 at its outer end 94 turn or curve inwardly from the outer wall 98 towards the inner wall 102. In one embodiment, the tip 106 is formed by a 0.25 mm radius. This configuration results in contact with a mating bore of a piston diameter when the piston is traveling in both up and down directions. This reduces wear on the piston, improves sealing properties and reduces friction in the bore which results in improved performance.

Referring to the inner end 90 of the sealing lip 46, there is a desired angle at which the sealing lip 46 extends away from the peripheral edge of the base 34. In a preferred embodiment, as identified in FIG. 5, the sealing lip 46 extends out at a nominal angle of 159°. This is a relatively steep angle which reduces stress on the sealing lip 46 as it flexes to fit inside a mating bore diameter. Its durability is increased and the susceptibility to wearing of the sealing lip 46 is reduced. Such an angle also allows the sealing lip 46 to be longer so that internal air pressure can have a greater sealing effect by acting on the inside of the sealing lip 46 and forcing it to take up the shape of the mating bore. At the portions of the inner wall 102 adjacent to the inner end 90, a suitable radius is defined coupling the base transition surface 42 and the inner wall 102 at the inner end 90. This coupling radius is preferably about 0.5 mm to provide improved durability and flexibility of the sealing lip 46.

Another important geometric constraint that can be incorporated relates to an angular dimension associated with the inner wall 102. As also seen in FIG. 5, this angle of inclination can be defined as being between the inner wall 102 and a line that is perpendicular to the base transition surface 42. This angle is at least 15° and preferably is 30°±20%. The dimensions associated with this inclined lip angle also contribute to sufficient flexibility and adequate durability.

In a preferred embodiment, all the preferred structures, geometries and dimensions are provided in the sealing device 30. However, it should be appreciated that suitable sealing devices can be configured having less than all of the novel features. For example, a novel configured height associated with a cross-section of a sealing lip could be employed which may include a thickness different from that disclosed herein. Similarly, a novel thickness might be employed in a sealing device that does not include a unique height. Likewise, one or more novel angles associated with the sealing lip might be incorporated apart from the heights and/or thicknesses disclosed herein.

The foregoing discussion of the invention has been presented for purposes of illustration and description. The description is not intended to limit the invention to the form disclosed herein. Consequently, variations and modifications commensurate with the above teachings, within the skill or knowledge of the relevant art, are within the scope of the present invention. By way of example only, multiple sealing lips in combination could be employed including in a spool valve design where they are disposed back to back and in series. The embodiments discussed hereinabove are further intended to explain the best mode known of practicing the inventions and to enable others skilled in the art to utilize the inventions in such, or in other embodiments, and with the various modifications required by their particular application or uses of the inventions. It is intended that the appended claims be construed to include alternative embodiments to the extent permitted by the prior art.

What is claimed is:

1. A sealing device comprising:
a base having a center axis, a base transition surface and an edge; and a lip integral with said base transition surface and having an inner end and an outer end with said inner end being adjacent to said base transition surface, said lip having at least a first cross-section with a height and one or more thicknesses including at least a first thickness, said first thickness being not less than any other thickness of said first cross-section, a ratio of said height and said first thickness being at least 2.5.

2. The sealing device of claim 1 wherein said height is at least 1.25 mm.

3. The sealing device of claim 1 wherein said first thickness is no greater than 0.90 mm.

4. The sealing device of claim 1 wherein said lip has an outer wall and an inner wall and said inner wall is located more adjacent said base center axis than is said outer wall, said inner wall and a line perpendicular to said base transition surface defining a lip angle that is at least 15°.

5. The sealing device of claim 1 wherein said height of said lip is definable by an upper half and a lower half and with at least a substantial majority of said lower half having a greater thickness than said upper half.

6. The sealing device of claim 1 wherein said first cross-section has a plurality of thicknesses that substantially continuously decrease from said inner end to said outer end.

7. The sealing device of claim 1 wherein said base and said lip are included in one of a piston assembly, a valve assembly and a spool assembly.

8. The sealing device of claim 1 wherein said lip has an outer wall with upper portions and an inner wall with upper portions, said outer wall upper portions curving inwardly toward said inner wall upper portions and said outer end has a tip that is more adjacent to said inner wall than to said outer wall.

9. A sealing device, comprising:
a base having a center axis, a base transition surface and an edge; and a lip integral with said base and being adjacent to said base edge, said lip having an outer end and an inner end with said inner end being adjacent to said base transition surface and having an outer wall and an inner wall with said inner wall being more adjacent to said base center axis than is said outer wall, said lip having at least a first cross-section with a height and one or more thicknesses including a first thickness, said height extending between said inner end and said outer end and said one or more thicknesses extending between said inner wall and said outer wall, said height being at least 1.80 mm and each of said one or more thicknesses being no greater than 0.90 mm.

10. The sealing device of claim 9 wherein said height has an upper half terminating in said outer end and a lower half terminating in said inner end, said first cross-section has a plurality of thicknesses with a number of said plurality being in said upper half and a number of said plurality being in said lower half and in which a majority of said number of said thicknesses of said lower half are greater than a majority of said number of thicknesses in said upper half.

11. The sealing device of claim 9 wherein a line perpendicular to said base transition surface and said inner wall define an angle that is at least 15°.

12. The sealing device of claim 9 wherein said outer end curves inwardly from said outer wall to said inner wall and said outer end has a tip that is located more adjacent to said inner wall than to said outer wall.

13. The sealing device of claim 9 wherein said lip has a perimeter and cross-sections of a majority of said perimeter are equivalent in height and thickness to said at least first cross-section.

14. The sealing device of claim 9 wherein said thickness of said first cross-section is greater adjacent to said inner end than to said outer end.

15. A sealing device, comprising:
a base having a base transition surface, a center axis and an edge; and a lip integral with said base and being adjacent to said edge, said lip having an outer end and an inner end with said inner end being more adjacent to said base transition surface, said lip having an outer wall and an inner wall with said inner wall being more adjacent to said base center axis, said lip having at least a first cross-section with a height and at least a first thickness, said height extending between said inner end and said outer end and said first thickness extending between said inner wall and said outer wall, said height being at least 1.25 mm and an angle of at least 15° being defined by a line perpendicular to said base transition surface and said inner wall.

16. The sealing device of claim 15 wherein said height is definable as having an upper half and a lower half and with said upper half terminating in said outer end and said lower half terminating in said inner end, said first cross-section has a plurality of thicknesses and said upper half has a number of thicknesses of said plurality and said lower half has a number of thicknesses of said plurality, a majority of said number of thicknesses of said lower half being greater than a majority of said number of thicknesses of said upper half.

17. The sealing device of claim 15 wherein a ratio of said height to said first thickness of said first cross-section is at least 2.5 and in which no other thickness of said first cross-section is greater than said first thickness.

18. The sealing device of claim 15 wherein said lip has a perimeter whereby a number of cross-sections can be defined along said perimeter including said first cross-section and in which at least a majority of said cross-sections have a ratio of height to thickness of at least 2.5 and in which for each of said cross-sections said thickness of said ratio is not less than any other thickness of each said cross-section.

19. The sealing device of claim 15 wherein said height of said first cross-section is at least 1.25 mm and said thickness of said first cross-section is less than 0.90.

20. The sealing device of claim 15 further including a boss integrally joined to said base and being less in width than said base.
